(19) United States
(12) Patent Application Publication
(10) Pub. No.: US 2015/0220411 A1
(43) Pub. Date: Aug. 6, 2015

(54) SYSTEM AND METHOD FOR OPERATING SYSTEM AGNOSTIC HARDWARE VALIDATION

(71) Applicant: Suhas Shivanna, Bangalore (IN)

(72) Inventor: Suhas Shivanna, Bangalore (IN)

(21) Appl. No.: 14/414,448

(22) PCT Filed: Jul. 17, 2012
(86) PCT No.: PCT/IN2012/000502

§ 371 Date: Jan. 12, 2015

(51) Int. Cl. G06F 11/263; G06F 11/14

(52) U.S. Cl. CPC G06F 11/263; G06F 11/1417; G06F 11/1469

(57) ABSTRACT

A system and method for performing operating system (OS) agnostic hardware validation in a computing system are disclosed. In one example, a hardware validation test is invoked by a management processor. Further, input parameters are obtained based on the hardware validation test by the management processor. Furthermore, hardware devices are determined based on the hardware validation test and the input parameters by the management processor. In addition, a request is sent to perform the hardware validation test on the hardware devices to a system processor by the management processor. Moreover, the hardware validation test is run on the hardware devices by invoking associated hardware specific run-time drivers in a system firmware (SFW) by the system processor. Also, results of the hardware validation test are sent to the management processor by the system processor.

### BACKGROUND

Typically, hardware validation tools assist in detecting latent defects in computing systems and reducing support costs. Further, within enterprise servers, storage and networking devices, many hardware validation tools, with different algorithms, are available for testing hardware devices. For example, different classes of servers have their own set of hardware validation tools with different user interfaces and algorithms for testing hardware devices. Generally, these hardware testing solutions and validation tools may be categorized as operating system (OS) based solutions, also referred to as online diagnostic hardware tools, and offline based diagnostic solutions that boot-up using a stripped down kernel.

Due to server vendors supporting a multi OS strategy, the OS based solutions require a hardware validation tool for each supported OS. This would mean increased development and maintenance cost to support hardware testing solutions on different OS's. Further, when a system is not bootable to the OS or a unified extensible firmware interface (UEFI) shell, current solutions require booting to an offline diagnostic environment. Such offline based diagnostic solutions may result in additional downtime and in many instances require configuration revisions to boot to a hardware device, including the kernel and the required hardware diagnostic tools.

Currently, there are many hardware validation tools. One existing technique is an OS based hardware validation tool. This is an OS application and normally needs to be ported to all supported OS's. However, this solution does not work when a server is not bootable. Another existing technique uses an extensible firmware interface (EFI) based hardware validation tool. However, typically, this EFI based hardware validation tool cannot be used when a server is fully booted or when the server is not bootable to the EFI. Yet another existing offline diagnostic hardware validation tool requires booting using a different image hosted on a disk or universal serial bus (USB) device and may further require additional manageability overheads and customer configurations. One existing technique uses a hardware checkout firmware for validating prototypes, which requires a different firmware, and is designed to work mainly during prototype validation.

### BRIEF DESCRIPTION OF THE DRAWINGS

Examples of the invention will now be described in detail with reference to the accompanying drawings, in which:

FIG. 1 illustrates an example flow diagram of a method for performing operating system (OS) agnostic hardware validation in a computing system; and

FIG. 2 illustrates an example block diagram including major components of the computing system and their interconnectivity for implementing the OS agnostic hardware validation, shown in FIG. 1.

The drawings described herein are for illustration purposes only and are not intended to limit the scope of the present disclosure in any way.

### DETAILED DESCRIPTION

A system and method for operating system (OS) agnostic hardware validation are disclosed. In the following detailed description of the examples of the present subject matter, references are made to the accompanying drawings that form a part hereof, and in which are shown by way of illustration specific examples in which the present subject matter may be practiced. These examples are described in sufficient detail to enable those skilled in the art to practice the present subject matter, and it is to be understood that other examples may be utilized and that changes may be made without departing from the scope of the present subject matter. The following detailed description is, therefore, not to be taken in a limiting sense, and the scope of the present subject matter is defined by the appended claims.

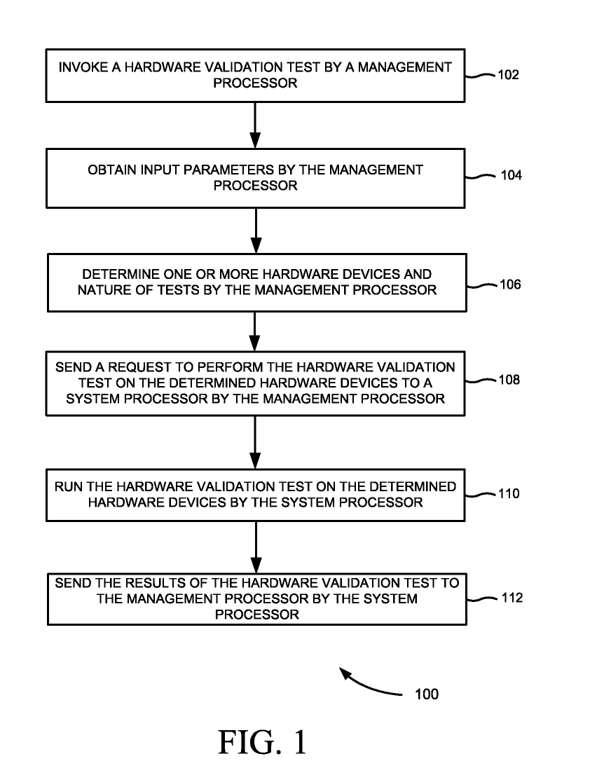

FIG. 1 illustrates an example flow diagram 100 of a method for performing OS agnostic hardware validation in a computing system. At block 102, a hardware validation test is invoked by a management processor. In one exemplary implementation, the management processor is communicatively coupled to a system processor in the computing system via shared memory or a physical inter processor communication (IPC) interface. For example, the physical IPC interface includes an Ethernet network interface that uses IPC, such as sockets and the like. In context, the hardware validation test to be run on one or more hardware devices is selected using an algorithm that is based on health and utilization data of the computing system and associated hardware devices. At block 104, input parameters are obtained by the management processor based on the invoked hardware validation test.

At block 106, the one or more hardware devices, in the computing system, and nature of tests to be performed on the hardware devices are determined based on the invoked hardware validation test and obtained input parameters by the management processor. For example, the hardware devices, types of hardware validation tests and stress levels are automatically selected based on spatial relationship data of the selected hardware devices in the computing system. The stress levels are determined based on current utilization data and predicted future utilization data obtained using historical utilization data. For example, the spatial relationship data is defined at a system design time frame, providing hardware links between different subsystems in the computing system.

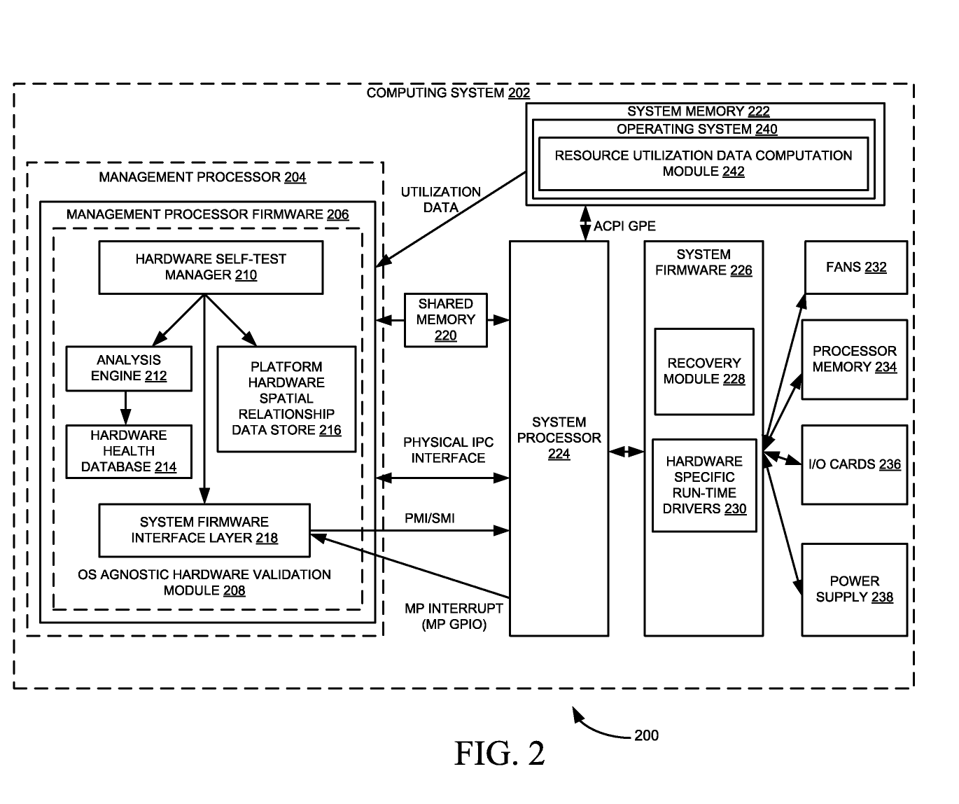

At block 108, a request is sent to the system processor for performing the hardware validation test on the determined hardware devices based on the nature of the tests to be performed on the determined hardware devices via the shared memory or physical IPC interface by the management processor. At block 110, the hardware validation test is run on the determined hardware devices by invoking associated one or more hardware specific run-time drivers in a system firmware (SFW) by the system processor upon receiving the request to perform the hardware validation test from the management processor. This is explained in more detail with reference to FIG. 2. At block 112, the results of the hardware validation test are sent to the management processor via a request/response protocol using the shared memory or physical IPC interface by the system processor.

In one embodiment, if the OS is not running and the computing system is not in a bootable state, a non-bootable computing system state is detected by the management processor. Further, appropriate flags are set in the shared memory to indicate a need for a recovery module to the SFW upon detecting the non-bootable computing system state by the management processor. Furthermore, the set appropriate flags are detected by the SFW to bypass normal boot-up and load an image of a recovery firmware volume containing one or more hardware specific run-time drivers for the hardware validation. In addition, a failing hardware device is determined by running the hardware validation test on each of the hardware devices by the management processor. Moreover,the determined failed hardware device is deconfigured by the management processor. Also, the set appropriate flags are reset to boot from the recovery firmware volume and the computing system is rebooted by the management processor.

In another embodiment, when the OS is up and a support engineer wants to run a proactive hardware validation test, the hardware validation test is parsed into chunks of smaller hardware validation tests by the management processor. For example, the smaller hardware validation tests are non-destructive tests, such as read only tests for memory, save context tests, central processing unit (CPU) tests for restoring context strategy and the like. Further,each of the smaller hardware validation tests is proactively, periodically run on the determined hardware devices using a SFW and manageability firmware (MFW) request/response protocol by the management processor. For example, each of the smaller hardware validation tests is proactively, periodically run on the determined hardware devices based on the utilization data obtained from the OS to reduce performance impacts resulting from the hardware validation test. The utilization data includes computing system load data and the like. The management processor uses an intelligent algorithm based on the utilization data obtained from the OS to schedule the hardware validation test using cycle stealing techniques when load is less, thereby reducing degradation of performance of a customer application.

In yet another embodiment, when the OS support is required to run the hardware validation test, the OS is required to register an interrupt handler, the hardware validation test is invoked from the OS using an advanced configuration and power interface general purpose event (ACPI GPE) mechanism from the management processor to interrupt the OS. Further, appropriate hardware specific unified extensible firmware interface (UEFI) un-time drivers are invoked to perform the hardware validation test by the registered interrupt handler. Furthermore, the hardware validation test is performed on the hardware devices. In addition, the results of the hardware validation test are sent to the management processor via the shared memory using the request/response protocol.

Referring now to FIG. 2, which is an example block diagram 200 including major components of a computing system 202 and their interconnectivity for implementing the OS agnostic hardware validation, shown in FIG. 1. As shown in FIG. 2, the computing system 202 includes a management processor 204, shared memory 220, system memory 222, a system processor 224, a system firmware (SFW) 226, fans 232, processor memory 234, input/output (I/O) cards 236, and a power supply 238. Further, the management processor 204 includes a management processor firmware 206. Furthermore, the management processor firmware 206 includes an OS agnostic hardware validation module 208. In addition, the OS agnostic hardware validation module 208 includes a hardware self-test manager (HSTM) 210, an analysis engine 212 to proactively determine health of the computing system 202, a hardware health database 214 containing the current health of all hardware devices in the computing system 202, a platform hardware spatial relationship data store 216 containing relationship information between different hardware devices in the computing system 202, and a SFW interface layer 218. Moreover, the SFW 226 includes a recovery module 228 and hardware specific run-time drivers 230. Also, the system memory 222 includes an OS 240. Further, the OS 240 includes a resource utilization data computation module 242.

Furthermore, the management processor firmware 206 is communicatively coupled to the system processor 224 via the shared memory 220 or a physical IPC interface. In addition, the system processor 224 is communicatively coupled to the SFW 226, the system memory 222 and the SFW interface layer 218. Moreover, the SFW 226 is communicatively coupled to the fans 232, processor memory 234, I/O cards 236, and power supply 238. The SFW 226 is communicatively coupled to the fans 232 and power supply 238 even if the fans 232 and the power supply 238 are controlled directly by the management processor 204. Also, the HSTM 210 is coupled to the analysis engine 212, platform hardware spatial relationship data store 216, and SFW interface layer 218. Further, the analysis engine 212 is coupled to the hardware health database 214. Furthermore, the system memory 222 is coupled to the management processor firmware 206.

In operation, the HSTM 210 invokes a hardware validation test. For example, the HSTM 210 initiates and manages hardware validation test invocation on different hardware devices and can be configured in an automatic mode or a manual mode. In context, the HSTM 210 selects the hardware validation test to run on one or more hardware devices using an algorithm that is based on health and utilization data of the computing system 202 and associated hardware devices obtained from the hardware health database 214 and resource utilization data computation module 242. The resource utilization data computation module 242 sends the utilization data to the HSTM 210 via an in band interface, such as an intelligent platform management interface (IPMI) and the like. For example, the hardware devices include the fans 232, processor memory 234, 110 cards 236, power supply 238 and the like. In some cases, the hardware devices, such as the fans 232 and power supply 238 are controlled directly by the management processor 204. By default, the HSTM 210 turns off the auto invocation of the hardware validation test when the OS 240 is up, running a business application. In the manual mode, the HSTM 210 provides a user interface to invoke the hardware validation test.

Further, the HSTM 210 obtains input parameters based on the invoked hardware validation test. Furthermore, the HSTM 210 determines the one or more hardware devices, in the computing system 202, and nature of tests to be performed on the hardware devices based on the invoked hardware validation test and the obtained input parameters. In the automatic mode, the HSTM 210 supports different types of tests (e.g., periodic, event based and the like) and appropriate policies are configured using a condition and state of the computing system 202. In one exemplary implementation, the HSTM 210 automatically selects the hardware devices, the types of tests and stress levels based on spatial relationship data of the selected hardware devices in the computing system 202 obtained from the platform hardware spatial relationship data store 216. For example, the HSTM 210 determines the stress levels based on current utilization data and predicted future utilization data obtained using historical utilization data. For example, the spatial relationship data is defined at a system design time frame, providing hardware links between different subsystems in the computing system 202. In the manual mode, the user interface allows selection of input parameters like hardware device types, test types, stress levels and the like.

In addition, the HSTM 210 sends a request to the system processor 224 to perform the hardware validation test on the determined hardware devices based on the nature of the tests to be performed on the hardware devices via a request/response protocol using the shared memory 220 or the physical IPC interface. In one case, the HSTM 210 sends parameters in the shared memory 220 and triggers a power management interrupt/system management interrupt (PMI/SMI) for which the SFW 226 registered an interrupt handler. Moreover, the SFW 226 runs the hardware validation test on the determined hardware devices by invoking associated one or more hardware specific run-time drivers 230 upon receiving the request to perform the hardware validation tests from the HSTM 210. The hardware specific run-time drivers 230 include firmware volumes with UEFI runtime drivers used to support the normal boot. Also, the system processor 224 sends the results of the hardware validation test to the HSTM 210 via the request/response protocol using the shared memory 220 or the physical IPC interface. For example, the system processor 224 sends the results to the HSTM 210 via management processor general purpose I/O (MP GPIO) pins using an interrupt mechanism, such as a management processor interrupt mechanism. The hardware validation test data and results are marshalled/unmarshalled while transmitting between the management processor 204 and system processor 224.

In one embodiment, if the OS 240 is not running and the computing system 202 is not in a bootable state, the HSTM 210 detects a non-bootable computing system state using the analysis engine 212. Further, the HSTM 210 sets appropriate flags in the shared memory 220 to indicate a need for the recovery module 228 to the SFW 226 upon detecting the non-bootable computing system state. Furthermore, the SFW 226 detects the set appropriate flags to bypass normal boot-up and load an image of a recovery firmware volume containing the one or more hardware specific run-time drivers for the hardware validation test. The recovery module 228 includes the recovery firmware volume with drivers required to run the hardware validation test and boot with minimal functionality and is used when the computing system 202 is in the non-bootable state. The recovery module 228 is loaded only when the HSTM 210 detects that the computing system 202 is in the non-bootable state. In addition, the HSTM 210 determines a failing hardware device by running the hardware validation test on each of the hardware devices. Moreover, the HSTM 210 deconfigures the determined failed hardware device. Also, the HSTM 210 resets the set appropriate flags to boot from the recovery firmware volume and reboots the computing system 202. When configured in autocratic mode, the HSTM 210 runs a set of hardware validation tests based on the health of the computing system 202 in a serialized manner, one subsystem at a time and one hardware device at a e, and identifies the failed hardware device. In manual mode, the HSTM 210 waits for a support engineer or an administrator to provide inputs to run the required hardware validation tests.

In another embodiment, when the OS 240 is up and customer/support engineer wants to run proactive hardware validation tests, the HSTM 210 parses the hardware validation test into chunks of smaller hardware validation test. For example, the smaller hardware validation tests are non-destructive tests, such as read only tests for memory, save context tests, CPU tests for restoring context strategy and the like. Further, the HSTM 210 proactively, periodically runs each of the smaller hardware validation tests on the determined hardware devices using a SFW and MFW request/response protocol. For example, the HSTM 210 proactively, periodically runs each of the smaller hardware validation tests on the determined one or more hardware devices based on the utilization data obtained from the resource utilization data computation module 242 to reduce performance impacts resulting from the hardware validation tests. For example, the utilization data includes computing system load data and the like.

In yet another embodiment, when the OS support to run the hardware validation test, the OS 240 is required to register an interrupt handler, the HSTM 210 invokes the hardware validation test from the OS 240 using an ACPI GPE mechanism to interrupt the OS 240. Further, the registered interrupt handler invokes appropriate hardware specific UEFI run-time drivers to perform the hardware validation test. Furthermore, the SFW 226 performs the hardware validation test on the hardware devices. In addition, the SFW 226 sends the results of the hardware validation test to the management processor 204 via the shared memory 220 using the request/response protocol.

In various examples, the system and method described in FIGS. 1 and 2 propose OS agnostic hardware validation techniques. The OS agnostic hardware validation techniques enable to validate the one or more hardware devices in the computing system based on the utilization data, health data and spatial relationship data between different hardware devices of the computing system. Thus eliminating dependency on the OS and providing a comprehensive and optimized hardware validation test catering to many customer specific configurations and requirements. Further, the above OS agnostic hardware validation techniques enable validation of the one or more hardware devices when the computing system is in the non-bootable state.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method of performing operating system (OS) agnostic hardware validation in a computing system, comprising:
invoking a hardware validation test by a management processor;
obtaining input parameters based on the invoked hardware validation test by the management processor;
determining one or more hardware devices based on the invoked hardware validation test and the obtained input parameters by the management processor;
sending a request to perform the hardware validation test on the determined one or more hardware devices to a system processor by the management processor;
running the hardware validation test on the determined one or more hardware devices by invoking associated one or more hardware specific run-time drivers residing in a system firmware (SFW) by the system processor; and
sending results of the hardware validation test to the management processor by the system processor,

2. The method of claim 1, further comprising:
detecting a non-bootable computing system state by the management processor;
setting appropriate flags in shared memory to indicate a need for a recovery module to the SFW upon detecting the non-bootable computing system state by the management processor;
detecting the set appropriate flags by the SFW to bypass normal boot-up and bad an age of a recovery firmware volume containing one or more hardware specific run-time drivers for the hardware validation;
determining a failing hardware device by running the hardware validation test on each of the one or more hardware devices by the management processor;
deconfiguring the determined failed hardware device by the management processor; and
resetting the set appropriate flags to boot from the recovery firmware volume and rebooting the computing system by the management processor.

3. The method of claim 2, further comprising:
parsing the hardware validation test into chunks of smaller hardware validation tests by the management processor; and
proactively, periodically running each of the smaller hardware validation tests on the determined one or more hardware devices using a SFW and manageability firmware (MFW) request/response protocol by the management processor.

4. The method of claim 3, wherein the smaller hardware validation tests are non-destructive tests, wherein the non-destructive tests are selected from the group consisting of read only tests for memory, save context tests, and central processing unit (CPU) tests for restoring context strategy.

5. The method of claim 3, wherein proactively, periodically running each of the smaller hardware validation tests on the determined one or more hardware devices comprises:
proactively, periodically running each of the smaller hardware validation tests on the determined one or more hardware devices based on utilization data obtained from the OS to reduce performance impacts resulting from the hardware validation test, wherein the utilization data includes computing system load data.

6. The method of claim 3, further comprising:
invoking the hardware validation test from the OS using an advanced configuration and power interface general purpose event (ACPI GPE) mechanism by the management processor to interrupt the OS, when the OS support is required to run the hardware validation test, the OS is required to register an interrupt handler;
invoking appropriate one or more hardware specific run-time drivers to perform the hardware validation test by the registered interrupt handler;
performing the hardware validation rest on the determined one or more hardware devices; and
sending the results of the hardware validation test to the management processor via the shared memory using a request/response protocol.

7. The method of claim 1, wherein invoking the hardware validation test by the management processor comprises:
selecting the hardware validation test to run on the determined one or more hardware devices using an algorithm that is based on health and utilization data of the computing system and associated hardware devices.

8. The method of claim 1, wherein determining the one or more hardware devices comprises:
automatically selecting the one or more hardware devices, the types of tests and stress levels based on spatial relationship data of the elected one or more hardware devices in the computing system, wherein the spatial relationship data is defined at a system design time frame, providing hardware links between different subsystems in the computing system.

9. The method of claim 8, further comprising:
determining the stress levels based on current utilization data and predicted future utilization data obtained using historical utilization data.

10. The method of claim 1, wherein the physical IPC interface comprises an Ethernet network interface that uses IPC.

11. A computing system, comprising:
a system processor;
a system firmware (SFW) communicatively coupled to the system processor;
system memory coupled to the system processor;
an operating system (OS) residing in the system memory;
a management processor;
a management processor firmware residing in the management processor; and
an OS agnostic hardware validation module residing in the management processor firmware, wherein the OS agnostic hardware validation module includes a hardware self-test manager (HSTM), an analysis engine to proactively determine health of the computing system, a hardware health database containing current health of all hardware devices in the computing system, a platform hardware spatial relationship data store containing relationship information between different hardware devices in the computing system and a system firmware interface layer, wherein the HSTM invokes a hardware validation test, wherein the HSTM obtains input parameters based on the invoked hardware validation test, wherein the HSTM determines one or more hardware devices based on the invoked hardware validation test and the obtained input parameters, wherein the HSTM sends a request to perform the hardware validation test on the determined one or more hardware devices to the system processor, wherein the system processor runs the hardware validation test on the determined one or more hardware devices by invoking associated one or more hardware specific run-time drivers in the SFW, and wherein the system processor sends results of the hardware validation test to the HSTM

12. The system of claim 11, wherein the HSTM further detects a non-bootable computing system state and wherein the HSTM sets appropriate flags in shared memory to indicate a need for a recovery module to the SFW upon detecting the non-bootable computing system state.

13. The system of claim 12, wherein the SFW further detects the et appropriate flags to bypass normal boot-up and bad an image of a recovery firmware volume containing one or more hardware specific run-time drivers for the hardware validation,

14. The system of claim 13, wherein the HSTM further determines a failing hardware device by running the hardware validation test on each of the one or more hardware devices, wherein the HSTM deconfigures the determined failed hardware device and wherein the HSTM resets the set appropriate flags to boot from the recovery firmware volume and reboots the computing system.

15. A non-transitory computer-readable storage medium for performing operating system (OS) agnostic hardware validation in a computing system having instructions that when executed by a computing device, cause the computing device to:
invoke a hardware validation test by a management processor;
obtain input parameters based on the invoked hardware validation test by the management processor;
determine one or more hardware devices based on the invoked hardware validation test and the obtained input parameters by the management processor;
send a request to perform the hardware validation test on the determined one or more hardware devices to a system processor by the management processor;
run the hardware validation test on the determined one or more hardware devices by invoking associated one or more hardware specific run-time drivers residing in a system firmware (SFW) by the system processor; and
send results of the hardware validation test to the management processor by the system processor.
